(19) United States
(12) Patent Application Publication
(10) Pub. No.: US 2015/0279020 A1
(43) Pub. Date: Oct. 1, 2015

(54) Display Panel Characterization System With Flatness and Light Leakage Measurement Capabilities

(71) Applicant: Apple Inc., Cupertino, CA (US)

(72) Inventors: Nathan K. Gupta, San Francisco, CA (US); Supriya Goyal, Santa Clara, CA (US); Veysi Demir, Tucson, AZ (US); Patrick Kessler, Mountain View, CA (US); Hyungryul J. Choi, San Jose, CA (US)

(73) Assignee: Apple Inc., Cupertino, CA (US)

(21) Appl. No.: 14/229,649

(22) Filed: Mar. 28, 2014

(51) Int. Cl. G06T 7/00

(52) U.S. Cl. CPC G06T 7/0004; G06T 2207/30121; G09G 2300/0478; G09G 2360/145

(57) ABSTRACT

A display characterization system may be used to gather display flatness data and light leakage data from a display. The display characterization system may include a camera system that includes flatness measurement cameras and a light leakage measurement camera. The camera system may include a light guide plate covered with a patterned opaque layer or other planar light-emitting structures for emitting patterned light that is reflected from the display. A controller may use the light leakage measurement camera to capture light leakage data while a display backlight unit is on, a reference light source is on, and the planar light-emitting structures are not emitting light. The controller may use the flatness measurement cameras to capture flatness data while the backlight unit is off, the reference light source is off, and the light-emitting structures are reflecting light from the display.

### BACKGROUND

This relates generally to electronic devices and, more particularly, to electronic devices with displays.

Electronic devices often include displays. For example, cellular telephones, laptop computers, and monitors have displays.

Displays such as liquid crystal displays have arrays of display pixels formed from a layer of liquid crystal material that is sandwiched between glass layers such as a color filter layer substrate and a thin-film transistor layer substrate. The color filter layer, thin-film transistor layer, and the layer of interposed liquid crystal material are located between an upper polarizer and a lower polarizer. Backlight is provided from a backlight unit beneath the lower polarizer.

The color filter layer may have an array of colored elements for providing a display with the ability to display color images. The thin-film transistor layer may have display pixel electrodes and driving circuitry. During operation of the display, the electrodes apply electric fields of desired strengths to the liquid crystal material of respective display pixels. The strength of the applied electric field controls how much the polarization of light passing through the display is rotated by the liquid crystal material and thereby determines how much light is emitted by each display pixel.

Due to manufacturing variations, displays may not be perfectly flat. For example, glass layers in a display such as the glass layers that form substrates for the color filter and thin-film transistor layers in a display may have surfaces of variable flatness. Substrate flatness variations can lead to visible display artifacts. For example, when a layer of glass is bent, stress within the layer of glass may lead to stress-induced birefringence. Birefringence in the glass layers of a liquid crystal display may allow light to leak through the display, even when the display is attempting to display dark images.

The interplay between display flatness and light leakage can be complex. Unless accurate characterization measurements can be made, it may be difficult or impossible to improve display designs or manufacture displays with satisfactory performance.

It would therefore be desirable to be able to provide improved ways in which to measure the flatness and light leakage characteristics of a display.

### SUMMARY

A display characterization system may be used to gather display flatness data and light leakage data from a display. The display characterization system may have a support structure in which the display is mounted during characterization operations.

A reference light source may be mounted adjacent to the support structure and the display. The reference light source may supply light at a known intensity during light leakage measurements to help calibrate the system.

The display characterization system may include a camera system that includes flatness measurement cameras and a light leakage measurement camera. The light leakage measurement camera may be located between the flatness measurement cameras. The camera system may include a light guide plate covered with a patterned opaque layer or other planar light-emitting structures for emitting patterned light that is reflected from the display. The light leakage measurement camera and the flatness measurement cameras may capture images of the display through openings in the planar light-emitting structures.

The display may have a backlight unit. A controller may use the light leakage measurement camera to capture light leakage data while the backlight unit is on, the reference light source is on, and the planar light-emitting structures are not emitting light. The controller may use the flatness measurement cameras to capture flatness data while the backlight unit is off, the reference light source is off, and the light-emitting structures are reflecting light from the display. The controller may use captured data to create graphs and other reports that assist a designer in improving display performance and may be used to evaluate display performance during manufacturing operations.

### BRIEF DESCRIPTION OF THE DRAWINGS

FIG. 1 is a perspective view of an illustrative electronic device such as a laptop computer with a display in accordance with an embodiment.

FIG. 2 is a perspective view of an illustrative electronic device such as a handheld electronic device with a display in accordance with an embodiment.

FIG. 3 is a perspective view of an illustrative electronic device such as a tablet computer with a display in accordance with an embodiment.

FIG. 4 is a perspective view of an illustrative electronic device such as a display for a computer or other electronic device in accordance with an embodiment.

FIG. 5 is a cross-sectional side view of an illustrative display in accordance with an embodiment.

FIG. 6 is a diagram of a system that may be used to make display flatness and light leakage measurements in accordance with an embodiment.

FIG. 7 is a diagram showing illustrative fields of view for cameras in the system of FIG. 6 in accordance with an embodiment.

FIG. 8 is a graph in which light leakage and display flatness data have been displayed in accordance with an embodiment.

FIG. 9 is a flow chart of illustrative steps involved in characterizing a display by gathering display flatness data and light leakage data using a system of the type shown in FIG. 6 in accordance with an embodiment.

### DETAILED DESCRIPTION

Electronic devices may be provided with displays such as liquid crystal displays. A liquid crystal display can be characterized by making light leakage and flatness measurements using a characterization system. Characterization measurements may be used to improve display designs and can be used during manufacturing to ensure that displays meet expected performance criteria.

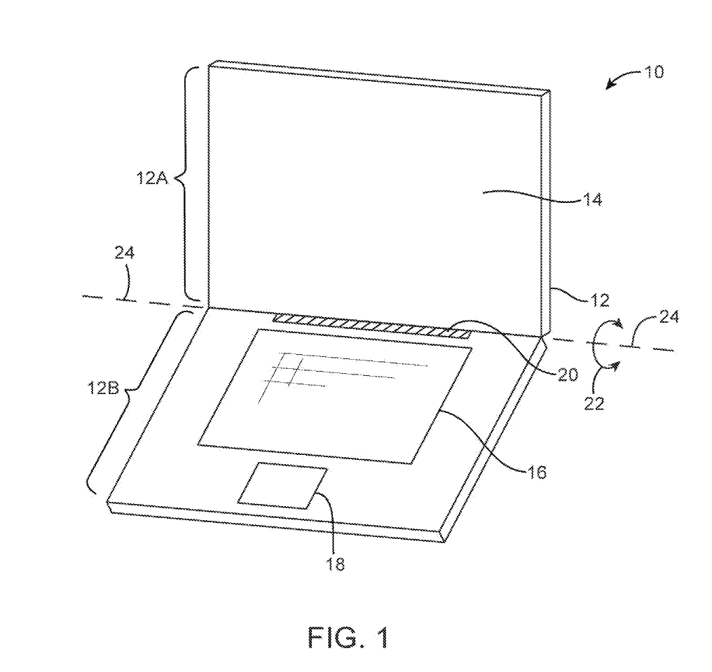

Illustrative electronic devices with displays of the type that may be can be characterized by making light leakage and flatness measurements are shown in FIGS. 1, 2, 3, and 4.

Electronic device 10 of FIG. 1 has the shape of a laptop computer and has upper housing 12A and lower housing 12B with components such as keyboard 16 and touchpad 18. Device 10 has hinge structures 20 (sometimes referred to as a clutch barrel) to allow upper housing 12A to rotate in directions 22 about rotational axis 24 relative to lower housing 12B. Display 14 is mounted in housing 12A. Upper housing 12A, which may sometimes be referred to as a display housing or lid, is placed in a closed position by rotating upper housing 12A towards lower housing 12B about rotational axis 24.

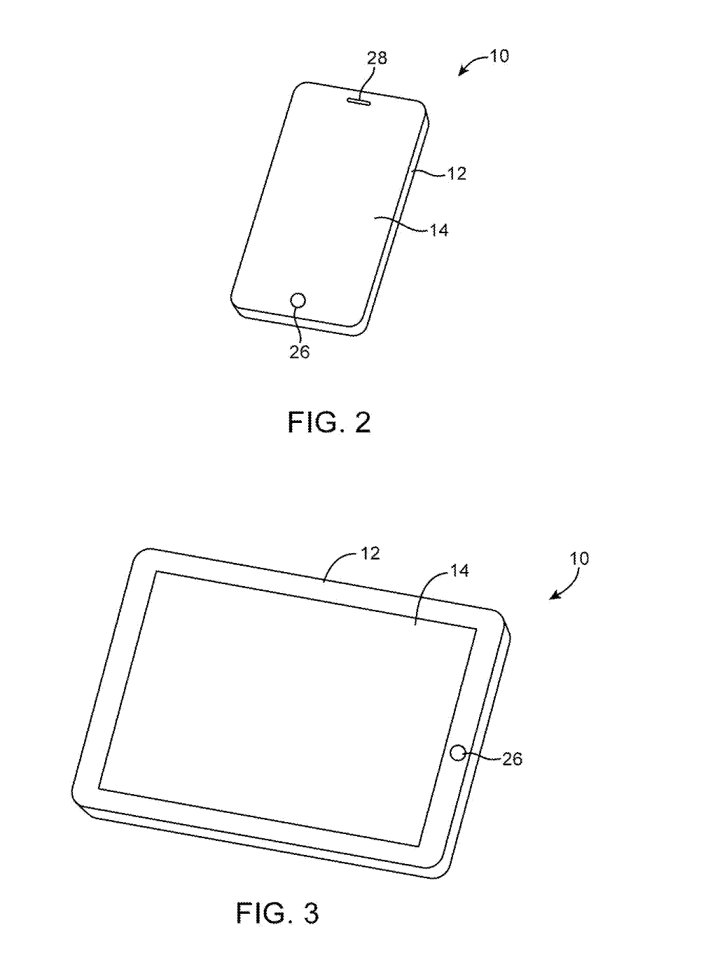

FIG. 2 shows an illustrative configuration for electronic device 10 based on a handheld device such as a cellular telephone, music player, gaming device, navigation unit, or other compact device. In this type of configuration for device 10, housing 12 has opposing front and rear surfaces. Display 14 is mounted on a front face of housing 12. Display 14 may have an exterior layer that includes openings for components such as button 26 and speaker port 28. Device 10 may, if desired, be a compact device such as a wrist-mounted device or pendant device (as examples).

In the example of FIG. 3, electronic device 10 is a tablet computer. In electronic device 10 of FIG. 3, housing 12 has opposing planar front and rear surfaces. Display 14 is mounted on the front surface of housing 12. As shown in FIG. 3, display 14 has an opening to accommodate button 26.

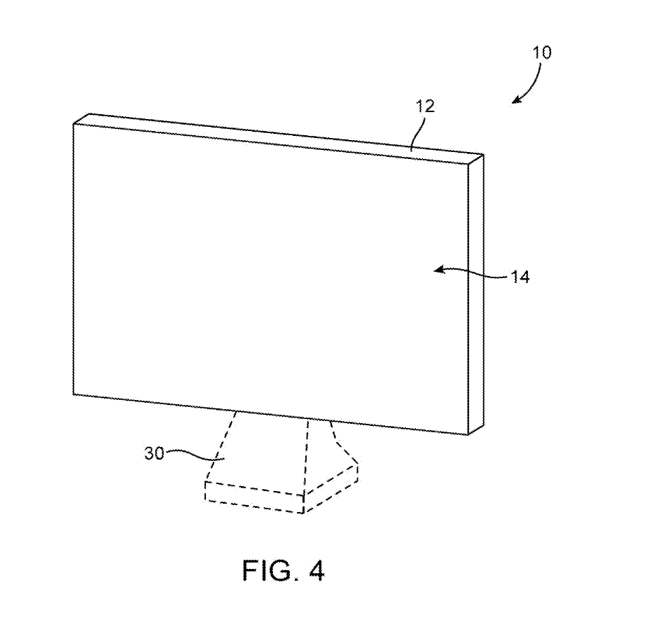

FIG. 4 shows an illustrative configuration for electronic device 10 in which device 10 is a computer display, a computer that has an integrated computer display, a stand-alone display for other equipment, a television, or other electronic device that includes a display. Display 14 is mounted on a front face of housing 12. With this type of arrangement, housing 12 for device 10 may be mounted on a wall or may have an optional structure such as support stand 30 to support device 10 on a flat surface such as a tabletop or desk.

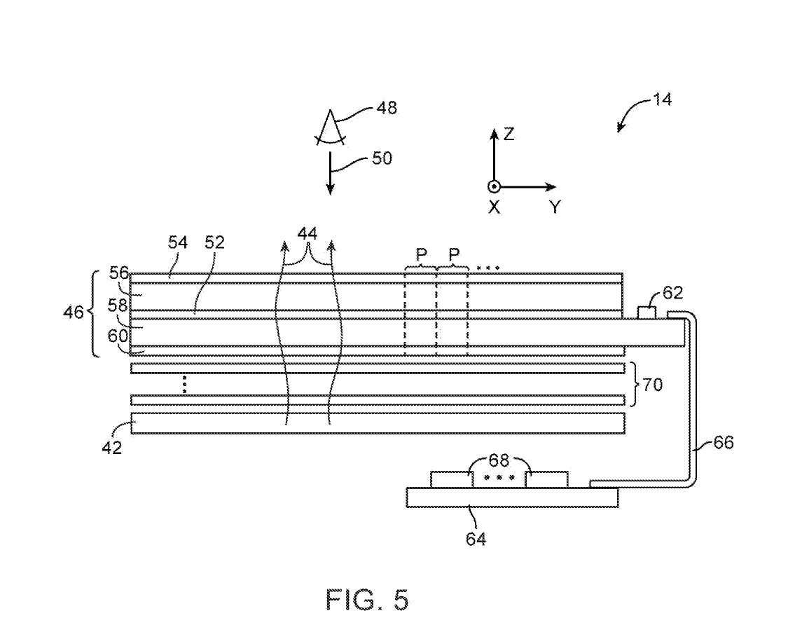

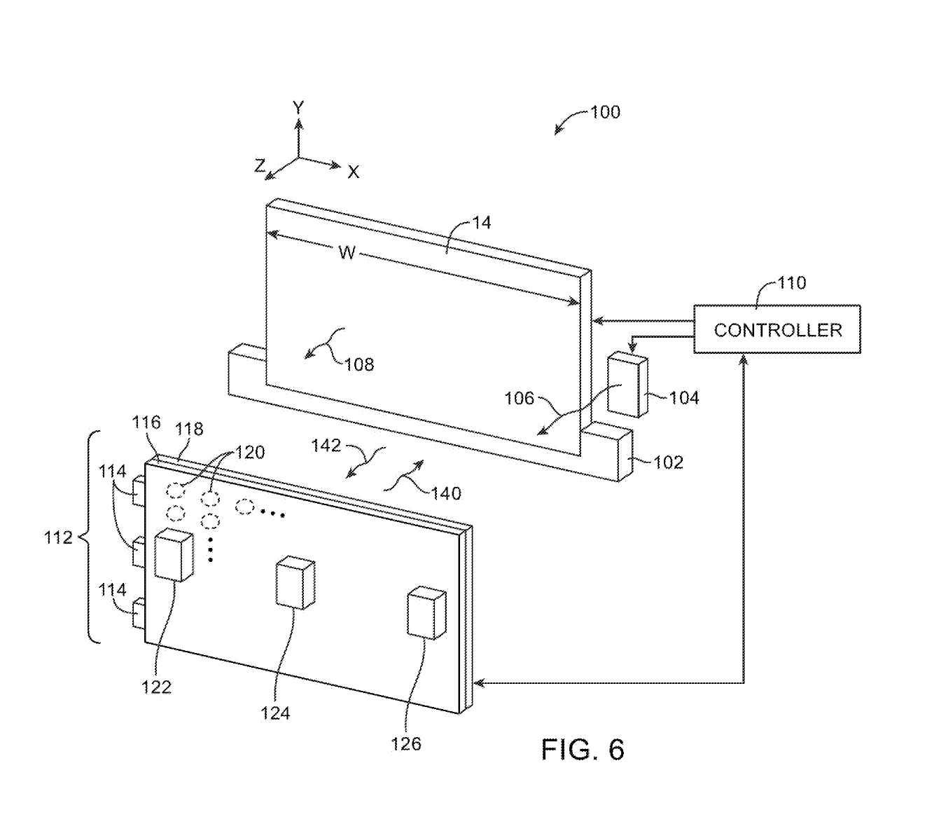

A cross-sectional side view of an illustrative configuration for display 14 of device 10 (e.g., a liquid crystal display for the devices of FIG. 1, FIG. 2, FIG. 3, FIG. 4 or other suitable electronic devices) is shown in FIG. 5. As shown in FIG. 5, display 14 may include display layers 46 that include an array of display pixels P for displaying images for a user and may include backlight structures such as backlight unit 42 for producing backlight 44. During operation, backlight 44 travels outwards (vertically upwards in dimension Z in the orientation of FIG. 5) and passes through the array of display pixels P in display layers 46. This illuminates any images that are being produced by the array of display pixels for viewing by a user. For example, backlight 44 may illuminate images on display layers 46 that are being viewed by viewer 48 in direction 50.

Display layers 46 may be mounted in chassis structures such as a plastic chassis structure and/or a metal chassis structure to form a display module for mounting in housing 12 or display layers 46 may be mounted directly in housing 12 (e.g., by stacking display layers 46 into a recessed portion in housing 12).

Display layers 46 may include a liquid crystal layer such a liquid crystal layer 52. Liquid crystal layer 52 may be sandwiched between display layers such as display layers 58 and 56. Layers 56 and 58 may be interposed between lower (innermost) polarizer layer 60 and upper (outermost) polarizer layer 54.

Layers 58 and 56 may be formed from transparent substrate layers such as clear layers of glass or plastic. Layers 56 and 58 may be layers such as a thin-film transistor layer and/or a color filter layer. Conductive traces, color filter elements, transistors, and other circuits and structures may be formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 may be a thin-film transistor layer that includes an array of thin-film transistors and associated electrodes (display pixel electrodes) for applying electric fields to liquid crystal layer 52 and thereby displaying images on display 14. Layer 56 may be a color filter layer that includes an array of color filter elements for providing display 14 with the ability to display color images. If desired, layer 58 may be a color filter layer and layer 56 may be a thin-film transistor layer.

During operation of display 14 in device 10, control circuitry (e.g., one or more integrated circuits on a printed circuit such as integrated circuits 68 on printed circuit 64) may be used to generate information to be displayed on display 14 (e.g., display data). The information to be displayed may be conveyed to display driver circuitry 62 using signal path 66. Display driver circuitry 62 may include one or more integrated circuits such as column driver integrated circuits for driving data signals onto corresponding data lines in display 14, gate driver circuitry for supplying gate signals to gate lines in display 14, and a timing controller (TCON) integrated circuit that supplies image data to the column drivers and gate driver controls signals to the gate driver circuitry. Display driver circuitry 62 may also include circuitry for controlling the application of backlight control signals to backlight unit 42. If desired, display driver circuitry for the display pixels of display 14 may be implemented using thin-film transistor circuitry (e.g., gate drivers or other driver circuitry on a thin-film transistor layer, etc.).

Backlight unit 42 may include a light guide plate. The light guide plate may be formed from a transparent sheet of plastic or other clear material. An array of light-emitting diodes or other light source may be used to launch light into one or more of the edges of the light guide plate. Light scattering features in the light guide plate may help scatter light upwards from the light guide plate through display 14 as backlight 44. A reflector mounted under the light guide plate may help reflect light that has scattered downwards in the −Z direction back in the upwards (+Z) direction, thereby enhancing backlight efficiency. If desired, backlight unit 42 may include an array of locally dimmable light-emitting diodes rather than an edge-illuminated light guide plate or may have other suitable light emitting structures.

Optical films 70 may be interposed between backlight unit 42 and display layers 46 and/or may be incorporated elsewhere in display 14. Optical films 70 may include diffuser layers for helping to homogenize backlight 44 and thereby reduce hotspots, compensation films for enhancing off-axis viewing, and brightness enhancement films (also sometimes referred to as turning films) for collimating backlight 44. Optical films 70 may overlap the structures in backlight unit 42. In configurations in which display layers 46 have a rectangular footprint in the X-Y plane of FIG. 5, optical films 70 and backlight unit 42 may have a matching rectangular footprint.

Display 14 may have an array of display pixels (e.g., a rectangular array having rows and columns) for displaying images to a viewer. Vertical signal lines called data lines may be used to carry display data to respective columns of display pixels. Horizontal signal lines called gate lines may be used to carry gate line signals (sometimes referred to as gate control signals or gate signals) to respective rows of display pixels.

Displays such as display 14 (sometimes referred to as display panels or panels) may be characterized using a system such as display characterization system 100 of FIG. 6. During characterization operations, display 14 (which may or may not be mounted in housing 12 or other support structures) may be supported using a support structure such as stand 102. System 100 may be used to gather both display flatness data and display light leakage data without needing to move display 14 from stand 102. This allows display flatness data and display light leakage data to be correlated accurately.

Display flatness measurements (i.e., measurements of the surface “height” of display 14 in dimension Z) and light leakage measurements (i.e., measurements of the amount of light emitted from display 14 when display 14 has been directed to display a completely black image) can be made using the same camera subsystem (camera subsystem 112), so that the relative positions of the flatness measurements and the light leakage measurements are well defined. By minimizing or eliminating uncertainties in the relative positions of the flatness and light leakage measurements, display 14 can be accurately categorized.

Camera subsystem 112 may include structures for emitting patterned light. In general, any suitable system may be used to emit patterned light (e.g., a light box, a light source such as a lamp or other light source that shines light through a patterned mask, etc.). With one suitable arrangement, which may be described herein as an example, subsystem 112 includes planar light-emitting structures that emit patterned light. Subsystem 112 may, for example, include a light source such as an array of light-emitting diodes 114 that emit light into the edge of a planar backlight structure such as a light guide plate (see, e.g., light guide plate 118). Light guide plate 118 may include bumps, pits, or other light scattering features that scatter light from light-emitting diodes 114 outwards as light 140. The backlight structure may include a rear reflector layer that helps reflect light that has been scattered in direction Z back towards display 14 in direction −Z. To pattern light 140, an opaque layer such as layer 118 may be placed over light guide plate 116. Layer 118 may be, for example, a black plastic film having an array of openings 120. Openings 120 may have the shape of circles, ovals, squares, rectangles, crosses, lines, or other suitable shapes. The pattern of openings 120 in opaque layer 118 defines a corresponding pattern of light 140 that is directed towards display 14. If, for example, openings 120 form an array of circles, layer 118 will allow a corresponding array of bright dots (light 140) to illuminate the surface of display 14. The array of dots or other patterned light 140 that is emitted by subsystem 112 is reflected from the front (outermost) surface of display 14 as reflected light 142.

Subsystem 112 includes one or more cameras or other digital image sensing equipment. The cameras may gather images through respective openings in the planar light-emitting structures of system 100 (e.g., openings in light guide plate 116 and film 118). In the example of FIG. 6, subsystem 112 includes left-hand camera 122, center camera 124, and right-hand camera 126. More than three cameras or fewer than three cameras may be used in system 100, if desired. The use of three cameras is merely illustrative.

Cameras 122, 124, and 126 may be used to gather flatness data and light leakage data from display 14. For example, cameras 122 and 126 may be used to gather flatness data, whereas camera 124 may be used to capture light leakage data. Cameras 122, 124, and 126 may have lenses that protrude through respective openings in layers 116 and 118 in direction −Z towards display 14. This allows cameras 122, 124, and 126 to gather images of display 14. Controller 110 (e.g., one or more networked computers, stand-alone computers or other computing equipment, microprocessors, or other electronic equipment) may be used to control the digital image capture process with cameras 122, 124, and 126 and may be used to process and analyze image data from cameras 122, 124, and 126.

When capturing flatness data, cameras 122 and 126 capture digital images of reflected light 142. For example, camera 122 may capture images of the left half of display 14, whereas camera 126 may capture images of the right half of display 14 while light 140 is being reflected from the surface of display 14 as reflected light 142. The captured image data from the left and right halves of display 14 can be digitally combined (i.e., digitally stitched together) to form a single image. To prevent internally generated light from display 14 (i.e., light from a backlight unit in display 14) from interfering with reflected light 142, backlight unit 42 of display 14 may be turned off by controller 110 during flatness data capture operations.

The position of reflected light 142 is affected by the flatness of display 14. For example, if display 14 has a surface portion that is tilted in a particular direction, the tilted nature of that surface portion will tend to deflect one or more of the dots that are used in illuminating display 14 (i.e., one or more of the dots in light 140 will be deflected so that reflected light 142 will contain light that that has shifted in position relative to its expected position). The deflection of the light rays in reflected light 142 reveals information on the surface topography of display 14. In particular, controller 110 can gather and process data from cameras 122 and 126 (i.e., digitally captured images of light 142) to determine the height (i.e., position in dimension Z) of each point on the surface of display 14. This height information represents deviations from an ideal planar surface and is therefore sometimes referred to as flatness data.

Camera 124 may be used to capture light leakage data. When capturing light leakage data, controller 110 may direct subsystem 112 to turn off light-emitting diodes 114, so that no patterned dots or other light 140 is used to illuminate display 14 from the planar light-emitting structures of camera system 112. At the same time, controller 110 may direct reference light source 104 to supply light 106 at a known intensity level and may direct display 14 to display a black image. Although display 14 is displaying a black image (i.e., although display 14 is nominally completely black), stress-induced birefringence effects and other effects can allow some amount of light 108 from backlight 42 to be emitted at various different locations on display 14. The known intensity of light 106 allows light 106 to serve as a reference for any light 108 that leaks out of display 14. Camera 124 may be used to gather digital images of display 14 when display 14 is displaying black image data and may normalize this data using the reference light intensity of emitted reference light 106. Controller 110 may gather light leakage image data from camera 124 and may process this data in conjunction with the flatness data gathered using cameras 122 and 126. This allows controller 110 to accurately plot light leakage data and flatness data on a common graph or to otherwise process and use the light leakage data and flatness data.

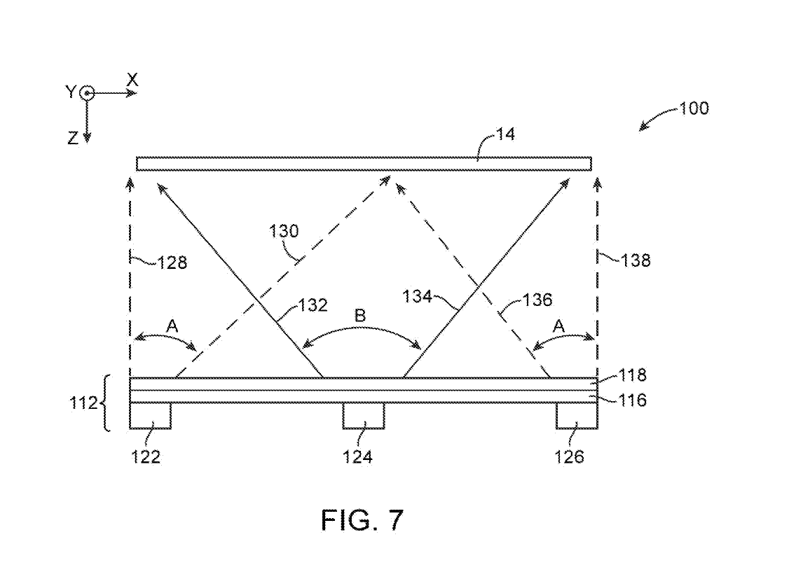

With an arrangement of the type shown in FIG. 7, left flatness measurement camera 122 and right flatness measurement camera 126 are configured to capture left and right halves of an image of display 14 while patterned light 140 is illuminating display 14. As shown in FIG. 7, camera 122 may have a field of view bounded by lines 128 and 130 and characterized by angle of view A. Camera 126 may have a complementary field of view bounded by lines 136 and 138 and characterized by an angle of view A. With this configuration, the field of view of left camera 122 covers the left half of display 14 so that camera 122 gathers flatness data from the left half of display 14, whereas the field of view of right camera 126 covers the right half of display 14 so that right camera 126 gathers flatness data from the right half of display 14. Controller 110 can stitch together the images from cameras 122 and 126 to produce an image of reflected light 142 on the entire surface of display 14. In a system of this type, only one seam line is involved when stitching together image data, but more than two cameras can be used to capture flatness data if more resolution if desired. A single high resolution camera may also be used in capturing flatness data or a system configuration in which both light leakage data and flatness data measurements are captured using a shared camera (or cameras) can be used.

Light leakage measurement camera 124 can gather light leakage data for all of display 14, because light leakage measurement camera 124 has a wide angle lens that provides camera 124 with a relatively wide field of view (i.e., a field of view bounded by lines 132 and 134 and characterized by angle of view B to cover all of display 14). The use of a single light leakage measurement camera may help speed image capture operations because no image stitching operations are required. In general, light leakage data may be gathered with sufficient accuracy using a single camera, but, if desired, two or more light leakage measurement cameras may be used in system 100 to enhance the resolution of the light leakage data.

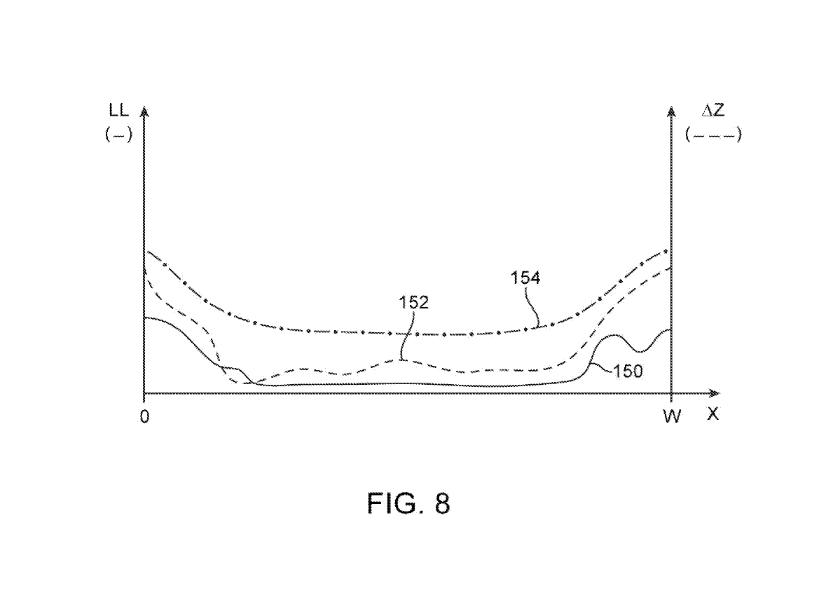

FIG. 8 is a graph of the type that may be produced by controller 110 by combining flatness data (i.e., data on the height AZ of display 14 in dimension Z of FIG. 6) and light leakage data (i.e., light intensity LL). In the graph of FIG. 8, light leakage data (i.e., measured light leakage level LL has been plotted as a function of distance X across the width of display 14 (line 150). Flatness data (height AZ) has also been plotted as a function of distance X across the width of display 14 (line 152). The graph of FIG. 8 is associated with a single location in display 14 in dimension Y, but, if desired, data of the type shown in FIG. 8 can be gathered across the entirety of display 14 and plotted in a three dimensional graph.

Because the flatness data and light leakage data were acquired by the same system (i.e., system 100 and camera subsystem 112) without moving display 14 (i.e., without removing display 14 from support stand 102 or other support structures), the data of line 150 is accurately aligned with respect to the data of line 152. As a result, potentially subtle relationships between flatness and light leakage can be investigated. If desired, light leakage curve 150 and/or flatness curve 152 can be compared to predetermined display performance criteria (see, e.g., illustrative performance threshold line 154). If curve 150 and/or curve 152 rises above the values established by curve 154 or other such criteria (in this example), display 14 may be identified as being defective or in need of additional processing. Accordingly, the use of performance criteria such as the criteria represented by illustrative line 154 may be used during manufacturing to determine whether or not display 14 is performing satisfactorily.

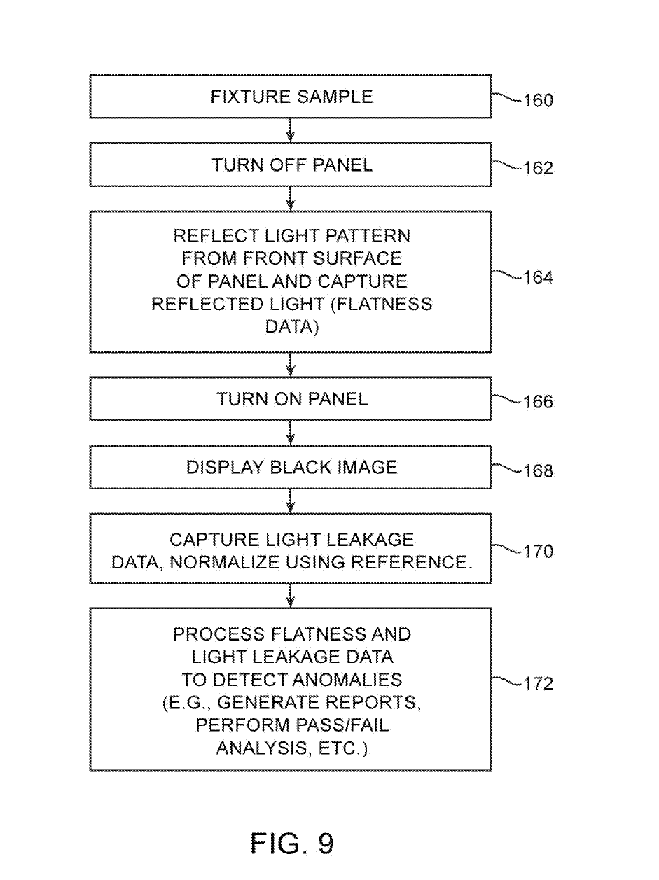

Illustrative steps involved in gathering flatness and light leakage data with a common measurement system such as system 100 of FIG. 6 is shown in FIG. 9.

At step 160, display 14 may be placed in a fixture such as support structure 120 of FIG. 6. Support structure 120 may include clamps or other structures for securing display 14 in a known position. If desired, computer-controlled positioners or other movable support structures may be used to position display 14 in a known position. The use of stand 102 to secure and help position display 14 is merely illustrative. Display 14 may be a working display panel that has not yet been installed into a support chassis or other structures associated with device 10 or may be installed in device 10 prior to positioning display 14 within fixture 102.

At step 162, controller 110 may turn off display 14 (i.e., the backlight unit in display 14). When display 14 is off (i.e., when the backlight in display 14 is off), no light 108 will leak from display 14. Controller 164 may also turn off reference light source 104 so that no reference light 106 is produced.

While backlight unit 42 of display 14 is off and reference light source 104 is off, controller 110 may direct subsystem 112 to produce patterned light 140. Light 140 may be produced by emitting light from light-emitting diodes 114 into light guide plate 116 so that light 140 is patterned into an array of dots by openings 120 in opaque layer 118. The dots or other pattern of light 140 may be reflected from the dark surface of display 14 as reflected light 142. Controller 110 captures flatness data (i.e., reflected light 142) using one or more flatness data measurement cameras such as cameras 122 and 1126 (step 164).

At step 166, after the flatness data has been captured, controller 110 may turn on display 14. In particular, controller 110 may direct display 14 to turn on backlight unit 42 (FIG. 5). At step 168, controller 110 may direct display 14 to display a black image (i.e., an image in which all of the display pixels are nominally black). Controller 110 may also turn on reference light source 104 to produce light 106 at a known intensity and may turn off the camera system light source (e.g., light-emitting diodes 114).

Some of the backlight from backlight unit 42 will leak through layers 46 even when layers 46 are configured to display a completely black image. This light leakage data (leaked light 108 of FIG. 6) may be captured at step 170 by controller 110 using one or more light leakage measurement cameras such as light leakage measurement camera 124 (or by using the same camera or cameras that were used in capturing flatness data). Light 106 may be captured during step 170 to allow the light leakage measurement data to be calibrated.

At step 172, controller 110 may process the data captured by cameras 122, 124, and 126. For example, controller 110 may combine flatness data and light leakage data and may display this information in a combined graph (see, e.g., FIG. 8). The graphed data may be examined by a display designer to determine whether the design for display 14 may be improved (as an example). The flatness and/or light leakage data may also be compared to predetermined criteria. For example, flatness data and/or light leakage data may be compared to threshold data (see, e.g., line 154 of FIG. 8). If the comparison indicates that the captured data varies from desired limits, display 14 may be reworked or discarded (i.e., system 100 may be used to implement pass/fail testing or other display performance testing during manufacturing operations in a manufacturing line).

The foregoing is merely illustrative and various modifications can be made by those skilled in the art without departing from the scope and spirit of the described embodiments. The foregoing embodiments may be implemented individually or in any combination.

What is claimed is:

1. A system for characterizing a display, comprising:
a support structure in which the display is supported;
a camera system that captures flatness data and light leakage data from the display supported by the support structure; and
a controller that processes the flatness data and light leakage data.

2. The system defined in claim 1 further comprising a reference light source adjacent to the support structure that emits reference light during light leakage data capture operations with the camera system.

3. The system defined in claim 2 wherein the camera system includes a camera system light source that emits patterned light during flatness data capture operations with the camera system.

4. The system defined in claim 3 wherein the camera system includes a flatness measurement camera that captures light reflected from the display while the camera system light source is emitting the patterned light during flatness data capture operations.

5. The system defined in claim 4 wherein the camera system includes a light leakage measurement camera that captures light from the display while the reference light source is emitting light and while the camera system light source is off.

6. The system defined in claim 5 wherein the display includes a backlight unit that is turned on during light leakage data capture operations with the camera system.

7. The system defined in claim 3 wherein the camera system includes a left-hand flatness measurement camera and a right-hand flatness measurement camera.

8. The system defined in claim 7 wherein the camera system includes a light leakage measurement camera between the left-hand flatness measurement camera and the right-hand flatness measurement camera.

9. The system defined in claim 8 wherein the left-hand flatness measurement camera has a field of view that covers a left half of the display, wherein the right-hand flatness measurement camera has a field of view that covers a right half of the display, wherein controller captures the flatness data using the left-hand flatness measurement camera and the right-hand flatness measurement camera while the reference light source is off, wherein the light leakage measurement camera has a field of view that covers all of the display, and wherein the controller captures the light leakage data using the light leakage measurement camera while the reference light source is on.

10. The system defined in claim 1 wherein the camera system includes a planar light-emitting structure that emits patterned light that reflects off of the display, wherein the display has a backlight, the system further comprising a reference light source adjacent to the support structure and the display, wherein:
the camera system includes a pair of flatness measurement cameras that capture images of the light reflected off of the display through openings in the planar light-emitting structure, wherein the pair of flatness measurement cameras capture the images while the display backlight is off and the reference light source is off, wherein the camera system includes a light leakage measurement camera that captures light through an opening in the planar light-emitting structure, and wherein the light leakage measurement camera captures the light while the backlight is on, the reference light source is on, and the planar light-emitting structure is not emitting light.

11. A system for characterizing a display, comprising:
a camera system that captures flatness data and light leakage data from the display; and
a controller configured to process the data from the camera system.

12. The system defined in claim 11 wherein the camera system includes a flatness measurement camera and a light leakage measurement camera.

13. The system defined in claim 11 wherein the camera system includes two flatness measurement cameras and a light leakage measurement camera.

14. The system defined in claim 13 wherein the camera system includes a light source that emits light that is reflected from a surface of the display and that is captured by the flatness measurement cameras.

15. The system defined in claim 14 further comprising:
a reference light source adjacent to the display that emits light while the light leakage measurement camera captures the light leakage data.

16. A method of characterizing a display supported by a support structure, comprising:
with a camera system, capturing flatness data and light leakage data from the display in the support structure; and
with a controller that is coupled to the camera system, processing the flatness data and the light leakage data.

17. The method defined in claim 16 wherein the display includes a backlight unit and wherein capturing the flatness data and light leakage data comprises:
capturing the flatness data with at least one flatness measurement camera while illuminating the display with a light source in the camera system while the backlight unit is off.

18. The method defined in claim 17 wherein capturing the flatness data and light leakage data comprises:
capturing the light leakage data with at least one light leakage measurement camera while the light source in the camera system is off and while the backlight unit is on.

19. The method defined in claim 18 wherein processing the flatness data and light leakage data comprises producing a graph in which both the flatness data and light leakage data are plotted as a function of position on the display.

20. The method defined in claim 18 wherein processing the flatness data and the light leakage data comprises comparing the flatness data and light leakage data to display performance criteria during manufacturing operations.
